(19) United States
(12) Patent Application Publication
(10) Pub. No.: US 2023/0286308 A1
(43) Pub. Date: Sep. 14, 2023

(54) PRINT CONTROL

(71) Applicant: Hewlett-Packard Development Company, L.P., Spring, TX (US)

(72) Inventors: Carlota GALINDO QUINTAS, Sant Cugat del Valles (ES); Andrei Alexandru DAFINOIU, Sant Cugat del Valles (ES); Antonio GRACIA VERDUGO, Sant Cugat del Valles (ES)

(73) Assignee: Hewlett-Packard Development Company, L.P., Spring, TX (US)

(21) Appl. No.: 18/006,239

(22) PCT Filed: Jul. 21, 2020
(86) PCT No.: PCT/US2020/042870

§ 371 Date: Jan. 20, 2023

(51) Int. Cl. B41J 29/393; B41J 11/42; B41J 2/21

(52) U.S. Cl. CPC B41J 29/393; B41J 11/42; B41J 2/2132; B41J 2029/3935

(57) ABSTRACT

The present disclosure relates to methods and devices for performing print control. In an example there is disclosed a control method. The control method may comprise programming a print mask to instruct printhead nozzles on a moveable carriage to deposit a first line of print material on a medium, wherein the print mask controls the depositing so that an edge of an area of the medium on which material is deposited defines a pattern which is repeated along a scan axis of the carriage and which differs in a direction of movement of the medium. The control method may further comprise scanning the first line of print material. The control method may further comprise performing control of subsequent print material depositing or medium advancement, based on the scan.

### BACKGROUND

Many printers deposit print material on a print medium. Printing may be carried out by passing the print medium along a printing path. A printer carriage may be passed over the print medium at a print location along a scan axis. The scan axis may be perpendicular to the direction of movement of the print medium along the printing path. Print media may be made of materials such as paper, Mylar, vinyl and textiles, for example. Print media may have different thicknesses. Such printers may include any 2D printers, such as piezo electric or thermal inkjet printers.

Inkjet printers may be provided with printheads for firing or spitting drops of ink or other printing fluid. In thermal inkjet printheads, ink may be ejected from a nozzle for example by using a heater resistor: when an electric voltage is applied, electric current flows through the heater resistor, heats the ink and causes it to eject from the nozzle. The printer may be a latex printer in which the printer ink may include latex or a latex polymer.

An inkjet printing system may include a printhead, an ink supply which supplies ink to the printhead, and an electronic controller which controls the printhead. The printhead may eject drops of ink through a plurality of nozzles or orifices and toward a print medium, such as a sheet of paper, so as to print onto the print medium. The orifices may be arranged in at least one column or array such that properly sequenced ejection of ink from the orifice causes characters or other images to be printed upon the print medium as the printhead and the print medium are moved relative to each other.

### BRIEF DESCRIPTION OF DRAWINGS

Non-limiting examples will now be described with reference to the accompanying drawings, in which:

FIG. 1 is a flowchart of a method according to some examples;

FIGS. 2a and 2b are examples of a print mask and print locations based on the print mask, respectively;

FIGS. 3a and 3b are examples relating to print medium advancement;

FIG. 4 is another flowchart of a method according to some examples a schematic; and

FIG. 5 is a device having a removable aerosol absorber according to some examples.

### DETAILED DESCRIPTION

Printing may be performed by depositing droplets of print material, such as ink, on a print medium. In some examples, printing may be performed by passing the print medium along a printing path. A printer carriage, housing a plurality of nozzles, may be passed over the print medium at a print location along a scan axis. The scan axis may be perpendicular to the direction of movement of the print medium along the printing path. A print location may be a specific point or may refer to an area.

In some examples, the carriage may perform printing with each movement over the print medium or may perform printing in one direction over the print medium, without performing printing on the return movement.

As a print medium is moved or advanced along the printing path, through the print location or print area, medium advance errors may occur, which may lead to banding-type defects in the printed image. Further, a print medium may advance inconsistently due to localised medium expansion, for example resulting from wet print material being absorbed into the medium.

In some examples, there is provided a method and device, for improving printed image quality for any 2D printer, by correcting for banding-type defects and localised medium expansion during printing of an image.

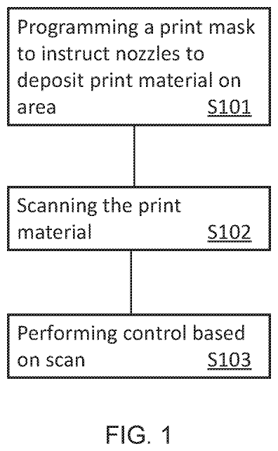

In some examples, in accordance with the disclosure, and as shown in FIG. 1, there is provided a control method. The control method may comprise programming S101 a print mask to instruct printhead nozzles on a moveable carriage to deposit a first line of print material on a medium. The print mask may control the depositing so that an edge of an area of the medium on which material is deposited defines a pattern which is repeated along a scan axis of the carriage and which differs in a direction of movement of the medium. The method may further comprise scanning S102 the first line of print material. The method may further comprise performing S103 control of subsequent print material depositing or medium advancement, based on the scan.

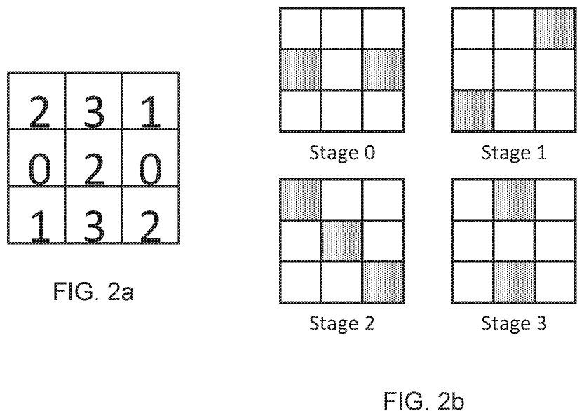

A print mask may for example be an array of numbers, each associated with a location on the print medium at which print material is to be deposited, and each associated with a print stage. Each line or part of an image may be printed in one stage or over a plurality of stages. For example, each carriage movement or pass may include a single stage in which print material is deposited onto a medium, or may include multiple stages in which print material is deposited onto a medium. The stages of a print pass or movement may involve printing different regions of a line or part of an image, in such a way so as to minimise interaction between deposited print material. For example, FIGS. 2a and 2b respectively show a representation of a print mask and the locations of nozzle instructed to fire in sequential stages of the print.

The edge may for example be the trailing edge, in the direction of movement of the print medium. The edge may be the boundary between where print material is deposited and where print material is not deposited, for a specific print movement. In other words, the edge may be adjacent to where subsequent print material deposition occurs. In some examples, depositing print material such that the edge has a specific pattern and subsequently scanning the deposited print material, including the edge, may allow the location of the print medium to be determined, and may allow any errors in advancement of the print medium between print material deposition procedures to be identified more quickly.

In some examples, the pattern defined by the edge may be a sinusoidal wave shape. Depositing print material such that the edge defines a pattern which is repeated across at least a part of the width of the print medium may allow the relative distances between specific points on the repeated pattern to be measured and compared in order to identify localised print medium expansion, which may occur for a number of reasons including for example absorption of wet print material such as ink into the print medium. A sinusoidal wave may be formed with a repeating wave across the print medium along the scan axis. A sinusoidal wave also differs in appearance in the direction of movement of the print medium, when scanned for example by a line scanner.

In some examples, the scanning may be performed by a scanner, for example a line scanner, which scans along a line of the print medium, on which print material of the first line may be deposited, along the scan axis. The scan axis extends across the print medium perpendicular to the direction of movement of the print medium.

In some examples, the pattern defined by the edge may differ in a direction of movement of the medium. In other words, scanning of the edge may allow identification of the location, along the transport path of the print medium, of the medium. Based on the location of the medium, any advancement error in the advancing of the medium may be identified and quantified.

According to some examples, as a print carriage passes along a scan axis over a print medium, print material, forming a first part of an image, may be deposited on the print medium. The print material may be deposited such that, based on the direction of movement of the print medium, the deposited print material forms a shape or pattern at the side adjacent to an area where the next part of the image is to be printed. The print medium may then be advanced by a specific amount and, during the next or second pass of the print carriage over the print medium, print material may be deposited in a corresponding or complementary manner, for example to “fill in the gaps” left by the shape or pattern of the first part of the image. Accordingly, the image printed is unaffected by the shape or pattern formed between print carriage passes.

In some examples, during the above-described second pass of the print carriage, the print material deposited during the first pass may be scanned, for example by a line scanner, to check the advancement of the print medium between the first pass and the second pass. Based on the scan, a determination may be made as to whether the medium has advanced by the correct amount, and therefore further material deposition may be carried out as normal, or whether there is a material advance error, and corrective measures may be taken to align the second part of the image with the first part, printed during the first pass.

In some examples, a print carriage movement or pass may include a single movement over the print medium. In some further examples, a print carriage movement or pass may include an outward movement and a return movement, back to the starting position.

Accordingly, the print material deposited during the first pass may either be scanned during the return movement of the print carriage or may be scanned during the second outward movement, during printing of the second part of the image. In some examples, the scanner may be located on the print carriage ahead of the print nozzles in the direction of movement of the print carriage when depositing print material. In some examples, two scanners may be located on the print carriage, and may be positioned either side of the print nozzles, along the scan axis, so that in either direction, the medium may be scanned ahead of the print material deposition.

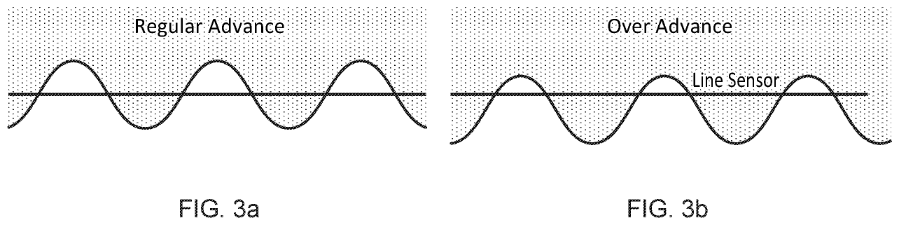

In some examples, the scanning is performed along the scan axis and a location of the medium is determined based on a location of the scanned sinusoidal wave shape. The location of the medium may be determined based on one of the amplitude of the wave and the distance between peaks. Depending on the relative positioning of the scanner and print medium with the deposited print material, the scanner may scan through the middle of the sinusoidal wave, as shown in FIG. 3a. FIG. 3a shows a correct advancement of the print medium. That is, the print medium has been advanced by the correct amount along the printing path following print material deposition during the first print carriage movement and the edge of the area in which the first part of the image was printed is correctly aligned so that the scanner scans the middle of the sinusoidal wave. Therefore, during the second print carriage movement, the second part of the image may be deposited in the correct location and image quality defects such as banding-type defects may be avoided.

FIG. 3b shows an example of over-advancement of the print medium. The edge of the area in which the first part of the image was printed is not positioned correctly, for example so that the scanner passes through the middle of the sinusoidal wave. The positioning of the line sensor may relate to the positioning of the printhead nozzles, such that a misalignment with the scanner may imply a misalignment with the printhead nozzles to print the second part of the image.

In some examples, the scanning of the first line of material is carried out while a second line of print material is deposited on the print medium. This process may be repeated iteratively for each part of the image to be printed with the preceding part of the image being scanned. Therefore, the image, and print medium advancement, may be scanned on a line-by-line basis, so that corrections in medium advancement may be made before printing of the immediately subsequent part of the image commences.

In some examples, the control performed comprises detecting an error in medium advancement and adjusting medium advancement for subsequent print material deposition based on the detected error. As shown in FIGS. 3a and 3b, the presence of a print medium advancement error may be detected based on the scan of the edge. As the edge is different/unique in appearance at every point in the direction of movement of the medium, the location of the print medium may also be deduced. Taking the sinusoidal wave as an example, based on the part of the wave being scanned, it may be determined whether an advancement error has occurred, whether that error is an over- or under-advancement, and by how much the print medium has been over- or under-advanced. The over- or under-advancement may be determined as a distance or as a number of pixels, for example. For example, when the edge is a sinusoidal wave, the amplitude of the wave may be sufficiently large that the subsequent scan may be of the wave and not fall adjacent to the wave. Medium advancement errors larger than the amplitude of the wave may result in printing being halted, so that a separate check may be made before continuing printing.

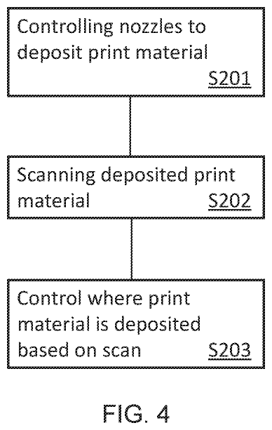

In some examples, in accordance with the present disclosure, and as shown in FIG. 4, there is provided a method. The method may comprise controlling S201 nozzles in a print carriage to deposit print material on a medium, based on a print mask, during a first movement of the carriage. One edge of an area onto which print material is deposited may differ in appearance along a direction of movement of the medium. The method may further comprise scanning S202 the deposited print material during a second movement of the carriage. The method may further comprise controlling S203 where print material is deposited during a third movement of the carriage, based on the scan.

The nozzles may in some examples be controlled by a print mask. In further examples, the nozzles may be controlled by a separate control means. The first movement of the carriage may be a first swath, or movement across the medium, over the print area. The one edge of the print area may be a leading edge of the print area. That is, the edge may be on a side adjacent to where a next print material deposit action is to take place. This may for example be referred to as the trailing edge in the direction of movement of the print medium.

In some examples, the scanning is performed while the nozzles deposit print material on the medium during the second movement of the carriage.

In some examples, controlling where print material is deposited comprises controlling medium advancement and/or controlling deposition from specific nozzles in the print carriage. Print material deposit location may be adjusted by advancing the medium more or less along the printing path, to correct for any errors in medium advancement. Medium advancement may for example be used to correct larger errors. In some examples, the method may further comprise setting a threshold amount, a distance or number of pixels, equal to or above which correction is performed by adjusting medium advancement.

Print material deposit location may also be adjusted by specifying which print nozzles, within the print carriage, are to fire to deposit print material onto the medium. A print carriage may have a plurality of nozzles for depositing print material onto a medium. In some examples, not all of the nozzle will fire during each print action (during each movement of the carriage during which print material is deposited). Therefore, small adjustments in the print material deposit location may be achieved by changing which nozzles are used to deposit the print material. In some examples, for errors below the threshold amount, correction may be performed by changing which nozzles are used for print material deposition. Changing which nozzles are used for print material deposition may be performed by programming the print mask accordingly, or by separate control means.

In some examples, the method may further comprise determining a location of the medium relative to an expected location of the medium, based on the edge, which is different in appearance along the direction of movement of the medium.

The appearance of the edge may change along the direction of movement of the medium.

In some examples, the edge further defines a repeating pattern, repeating along a scan axis. The edge may be scanned to detect the location of the repeating pattern, and to compare dimensions of the repeating pattern, to detect localised medium expansion. Localised medium expansion may for example create small inaccuracies in the location of subsequently deposited print material. Therefore, in the event localised medium expansion is detected, the print material deposit location may also be adjusted by specifying which print nozzles, within the print carriage, are to fire to deposit print material onto the medium. In some examples, the print mask may be updated to reduce deposited print material interaction, upon detection of localised print medium expansion.

In some examples, the method may further comprise setting a threshold medium advancement error amount, wherein controlling where print material is deposited comprises controlling medium advancement in an event an error amount is equal to or above the threshold and controlling deposition from specific nozzles in the print carriage in an event an error amount is below the threshold.

An error amount may be an amount of offset between the expected location of the print medium, based on print material deposited thereon and an expected medium advancement amount, and a detected location of the print medium, based on the scan.

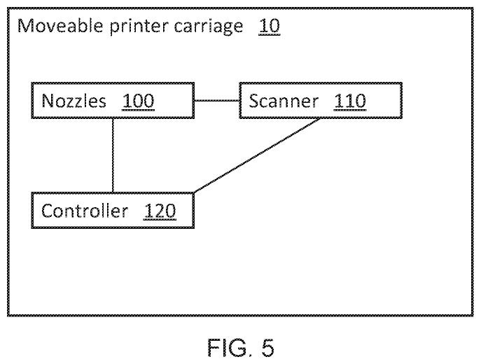

In some examples, in accordance with the present disclosure, and as shown in FIG. 5, there is provided a moveable printer carriage. The moveable printer carriage may comprise a plurality of nozzles to deposit print material onto a print medium at specific locations. The plurality of nozzles may be controlled by a print mask. The nozzles may deposit print material when the moveable printer carriage is moved over the print medium along a first line. The moveable printer carriage may further comprise an optical scanner to scan the deposited print material, deposited along the first line, when the nozzles are moved over a second line, adjacent the first line, to deposit print material along the second line. The moveable printer carriage may further comprise a controller to control where print material is deposited along a third line when the nozzles are moved over the third line, based on the scan. The third line may be located adjacent the second line. The deposited print material may be deposited along the first line on the print medium such that one edge of an area onto which print material is deposited changes in appearance along a direction of movement of the print medium.

The optical scanner may for example be a line scanner.

Each of the first, second and third lines may have a specific width. In some examples in which the edge of the area forms a sinusoidal wave shape, the width of the line corresponds to twice the amplitude of the wave, sometimes referred to as the peak-to-peak distance.

In some examples, the controller may control where print material is deposited by controlling medium advancement and/or controlling deposition location from specific nozzles of the plurality of nozzles. The controller may control the print mask, used to determine where print material is to be deposited. The controller may further control means for moving the print material along the printing path. Such means may include rollers, for example.

In some examples, the edge may further define a repeating pattern, repeating along a scan axis.

The repeating pattern may be repeated two or more times across the print medium. Increasing the number of times the repeating pattern is repeated may improve the accuracy of the identification of localised medium expansion.

In some examples, the optical scanner may scan instances of the repeating pattern and the controller may compare dimensions of each instance of the repeating pattern.

In some examples, the optical scanner may be positioned ahead of the nozzles, in a direction of movement of the moveable printer carriage, when print material is deposited.

In some examples, the carriage may comprise nozzles and an optical scanner and moves back and forth over the print medium to deposit print material. In a first movement, a line of print material may be deposited on the print medium. In a second movement, a further line of material may be deposited, while the optical scanner scans the first line for inaccuracies. Based on the scan, control may be performed in preparation for a third movement of the carriage to either adjust the movement of the medium, in the event any error in the first line is large, or to specify which print nozzles are to fire during the third movement, in the event any error in the first line is small.

For each movement, a print mask may be programmed such that the print material is deposited using a specific pattern, and in that pattern an edge of the line of print material may be deposited to form a specific shape such as a sinusoidal wave. The sinusoidal wave is one example of a pattern for the edge, but this pattern may be any pattern, which repeats along the scan axis (along the axis travelled by the carriage during print material deposition) and which changes in the direction of travel of the medium (the pattern may be visually different at each point along an axis perpendicular to the scan axis, with the plane of the print medium). In this way, the pattern may be scanned and advancement errors may be detected, but also localised medium expansion may be detected through comparing measurements of the dimensions of the repeating pattern. In some examples, the optical scanner is an in-line scanner that scans along a single line of the medium. The points at which the scan line intersects the pattern allow the positioning of the medium, and thus any advancement errors, to be deduced.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams may be realized by machine readable instructions.

Any machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions may be made without departing from the scope of the present disclosure. It is intended, therefore, that the methods, devices and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single unit may fulfil the functions of several units recited in the claims.

The features of any dependent claim may be combined with the features of any of the independent claims or other dependent claims.

1. A control method comprising:
programming a print mask to instruct printhead nozzles on a moveable carriage to deposit a first line of print material on a medium, wherein the print mask controls the depositing so that an edge of an area of the medium on which material is deposited defines a pattern which is repeated along a scan axis of the carriage and which differs in a direction of movement of the medium;
scanning the first line of print material; and
performing control of subsequent print material depositing or medium advancement, based on the scan.

2. The control method of claim 1, wherein the pattern defined by the edge is a sinusoidal wave shape.

3. The control method of claim 2, wherein the scanning is performed along the scan axis and a location of the medium is determined based on a location of the scanned sinusoidal wave shape.

4. The control method of claim 1, wherein the scanning of the first line of material is carried out while a second line of print material is deposited on the print medium.

5. The control method of claim 1, wherein the control performed comprises detecting an error in medium advancement and adjusting medium advancement for subsequent print material deposition based on the detected error.

6. A method comprising:
controlling nozzles in a print carriage to deposit print material on a medium, based on a print mask, during a first movement of the carriage, wherein one edge of an area onto which print material is deposited differs in appearance along a direction of movement of the medium;
scanning the deposited print material during a second movement of the carriage; and
controlling where print material is deposited during a third movement of the carriage, based on the scan.

7. The method of claim 6, wherein controlling where print material is deposited comprises controlling medium advancement and/or controlling deposition from specific nozzles in the print carriage.

8. The method of claim 6, further comprising determining a location of the medium relative to an expected location of the medium, based on the edge, which is different in appearance along the direction of movement of the medium.

9. The method of claim 6, wherein the edge further defines a repeating pattern, repeating along a scan axis.

10. The method of claim 6, further comprising setting a threshold error amount, wherein controlling where print material is deposited comprises controlling medium advancement in an event an error amount is equal to or about the threshold and controlling deposition from specific nozzles in the print carriage in an event an error amount is below the threshold.

11. A moveable printer carriage comprising:
a plurality of nozzles, controlled by a print mask, to deposit print material onto a print medium at specific locations, when the moveable printer carriage is moved over the print medium along a first line;
an optical scanner to scan the deposited print material, deposited along the first line, when the nozzles are moved over a second line, adjacent the first line, to deposit print material along the second line; and
a controller to control where print material is deposited along a third line, adjacent the second line, when the nozzles are moved over the third line, based on the scan, wherein
the deposited print material is deposited along the first line on the print medium such that one edge of an area onto which print material is deposited changes in appearance along a direction of movement of the print medium.

12. The moveable printer carriage of claim 11, wherein the controller is to control where print material is deposited by controlling medium advancement and/or controlling deposition location from specific nozzles of the plurality of nozzles.

13. The moveable printer carriage of claim 11, wherein the edge further defines a repeating pattern, repeating along a scan axis.

14. The moveable printer carriage of claim 13, wherein the optical scanner is to scan instances of the repeating pattern and the controller is to compare dimensions of each instance of the repeating pattern.

15. The moveable printer carriage of claim 11, wherein the optical scanner is positioned ahead of the nozzles, in a direction of movement of the moveable printer carriage, when print material is deposited.
